(19) United States
(12) Patent Application Publication
(10) Pub. No.: US 2011/0115903 A1
(43) Pub. Date: May 19, 2011

(54) INSPECTION SYSTEM AND METHOD FOR HIGH SPEED IMAGING

(75) Inventors: TAL SHALEM, Givat Ela (IL); Diana Shapirov, Yokneam (IL)

(73) Assignee: Camtek Ltd., Migdal Haemeq (IL)

(21) Appl. No.: 12/908,122

(22) Filed: Oct. 20, 2010

Related U.S. Application Data
(60) Provisional application No. 61/253,099, filed on Oct. 20, 2009.

(51) Int. Cl. H04N 7/18

(52) U.S. Cl. 348/135; 348/E07.085

(57) ABSTRACT

A method and an inspection system, the inspection system includes a camera comprising multiple pixels having a pixel width; a mechanical stage, for introducing a movement between an inspected object and optics of the inspection system; wherein the inspected object is expected to move a distance that substantially equals the pixel width during a pixel movement period; an illumination module and optics for illuminating inspected portions of the inspected object and for directing light from the inspected portions to the camera; and wherein the camera is arranged to acquire multiple acquired images of the inspected portions during each pixel movement period, wherein at least two acquired images partially overlap.

### RELATED APPLICATIONS

This application claims priority from U.S. patent provisional patent Ser. No. 61/253,099, filing date Oct. 20, 2009.

### BACKGROUND OF THE INVENTION

In the field of printed circuit board (PCB), wafer and other electronic work piece automatic optical inspection (as well as possibly other optical inspection systems), line scan techniques are commonly used.

A conventional line scan apparatus includes a line camera, an acquisition board, a processor (e.g. a PC, which may include additional components such as monitor etc.), optics, an illumination device, an object moving stage and a hardware motion control unit.

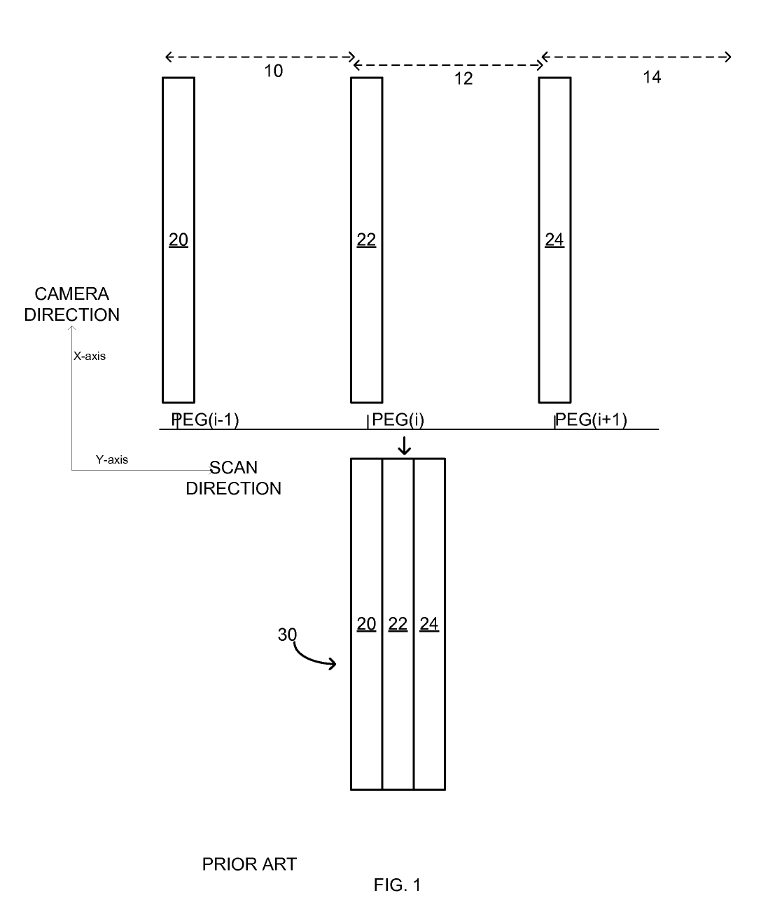

The line scan two dimensional image formation relies on scanned object moving. The camera clock, and hence the camera line readout period, are synchronized with the pixels-size equivalent moving object position, which in turn, is ruled by the programmable motion control signal (PEG) from a location encoder. The exposure period may be either fixed or programmable (externally or internally). The essence of the conventional approach is that the single PEG corresponds to the single camera readout, meaning the single line sampling and, hence, single image acquisition, e.g. as exemplified in FIG. 1.

FIG. 1 is a timing diagram that illustrates three images 20, 22 and 24 that are obtained during three different camera clock cycles 10, 12 and 14—each camera clock cycle is slightly longer than a camera exposure period. The readout of the images from the camera is performed in a pipelined manner—the images obtained during the i'th camera exposure period are outputted during the (i+1)'th camera exposure period. FIG. 1 also illustrates three pulses of the PEG signal denoted PEG(i−1), PEG(i) and PEG(i+1).

These non-overlapping images form a two dimensional image of the inspected object.

The longitudinal axis of the camera is referred to as camera direction or X-axis, while the scan direction is referred to as Y-axis.

The PEG signals can be generated in fixed timing intervals or after the inspected object moved a fixed distance.

The main characteristics of the conventional mentioned above image acquisition approaches:

(i) Geometrical resolution. The camera direction resolution (X-axis) is defined by the size of the pixel of the camera and the optical magnification provided by optics. The scan direction resolution (Y-axis) is defined by the camera line period which is fully synchronized with PEG signals generated by the moving object encoder.

(ii) Image quality. The X-axis sharpness (X-MTF) is significantly influenced by readout and sampling camera noise. The Y-axis sharpness (Y-MTF) is mostly determined by the ratio between the exposure and line periods.

(iii) The grey level signal of the raw Image is determined by the camera sensitivity and selected exposure period (given constant object reflectance/transmittance and illumination conditions).

(iv) Information Dimension: a single line provides a single-dimension information per object pixel.

The acquisition technique described above exhibits (i) strong impact of the digital sampling noise, especially at the high spatial frequency; (ii) significantly lowered MTF at the high spatial frequency; and (iii) comparatively low Signal to Noise Ratio under low lighting conditions due to significant partition of read-out noise.

There is therefore a need for systems and methods that would improve the image quality without changing geometrical resolution or/and scan throughput. Improvement is desired, inter alia, in the following parameters: image sharpness, visualization of tiny defects, SNR under low lighting conditions, and Image stability

### SUMMARY

According to an embodiment of the invention an inspection system is provided. The inspection system may include a camera; a mechanical stage, for introducing a movement between an inspected object and optics of the inspection system; wherein the inspected object is expected to move a distance that substantially equals a pixel width during a pixel movement period; an illumination module and optics for illuminating inspected portions of the inspected object and for directing light from the inspected portions to the camera; and wherein the camera may be arranged to acquire multiple acquired images of the inspected portions during each pixel movement period, wherein at least two acquired images partially overlap.

The inspection system may include an image processing unit for processing the acquired images to provide processed images; and a defect detection unit for detecting defects based on a processing of the processed images.

The image processing unit may merge different acquired images obtained during a single pixel movement period.

The image processing unit may generate multiple processed images, each processed image comprises acquired images obtained during different pixel movement periods, wherein each of the acquired images is obtained at a same timing difference from a beginning of the pixel movement period during which the acquired image was obtained.

The illumination module may be arranged to perform at least one alteration of at least one illumination characteristic during each pixel movement period.

The illumination module may be arranged to illuminate, during a single pixel movement period, different inspected object portions by light beams that differ from each other by wavelength.

The inspection system may be further adapted to illuminate, during a single pixel movement period, different inspected object portions by light beams that differ from each other by an angle of incidence.

The illumination module may be arranged to illuminate, during a single pixel movement period, different inspected object portions by light beams that differ from each other by wavelength and by angle of incidence.

The camera may be arranged to obtain at least three acquired images of the inspected portions during each pixel movement period.

The mechanical stage may be arranged to move the inspected object by a movement that is characterized by speed variations; and the inspection system may further includes: a signal generator, for generating triggering pulses at a fixed frequency regardless of the speed variations; a mechanical stage location generator, for providing location information indicative of a location of the mechanical stage at points of time that are determined by the triggering pulses; wherein the camera may be arranged to obtain acquired images in response to the triggering pulses; and wherein the image processing unit may be arranged to associate location information to the acquired images.

According to an embodiment of the invention a method is provided. The method may include introducing a movement between an inspected object and optics of an inspection system; wherein the inspected object is expected to move a distance that substantially equals a pixel width during a pixel movement period; illuminating inspected portions of the inspected object and directing light from the inspected portions to a camera; and acquiring, by the camera that has pixels of a pixel width, multiple acquired images of the inspected portions during each pixel movement period, wherein at least two acquired images partially overlap.

The method may include processing the acquired images to provide processed images; and detecting defects based on a processing of the processed images.

The method may include merging different acquired images obtained during a single pixel movement period.

The method may include generating multiple processed images, each processed image comprises acquired images obtained during different pixel movement periods, wherein each of the acquired images is obtained at a same timing difference from a beginning of the pixel movement period during which the acquired image was obtained.

The method may include performing at least one alteration of at least one illumination characteristic during each pixel movement period.

The method may include illuminating, during a single pixel movement period, different inspected object portions by light beams that differ from each other by wavelength.

The method may include illuminating, during a single pixel movement period, different inspected object portions by light beams that differ from each other by an angle of incidence.

The method may include illuminating, during a single pixel movement period, different inspected object portions by light beams that differ from each other by wavelength and by angle of incidence.

The method may include obtaining at least three acquired images of the inspected portions during each pixel movement period.

The method may include moving the inspected object by a movement that is characterized by speed variations; wherein the method may also include generating triggering pulses at a fixed frequency regardless of the speed variations; providing location information indicative of a location of the mechanical stage at points of time that are determined by the triggering pulses; obtaining acquired images in response to the triggering pulses; and associating location information to the acquired images.

### BRIEF DESCRIPTION OF THE PRESENT INVENTION

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

FIG. 1 is a timing diagram that illustrates three images that are obtained during three different camera clock cycles;

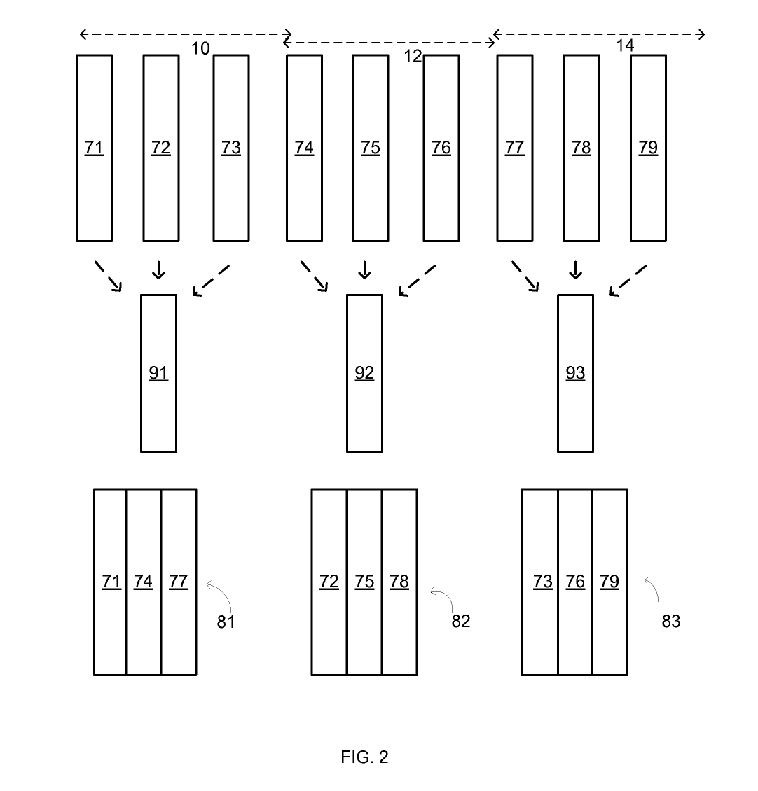

FIG. 2 illustrates three acquired images that are acquired during a single pixel movement period, according to an embodiment of the invention;

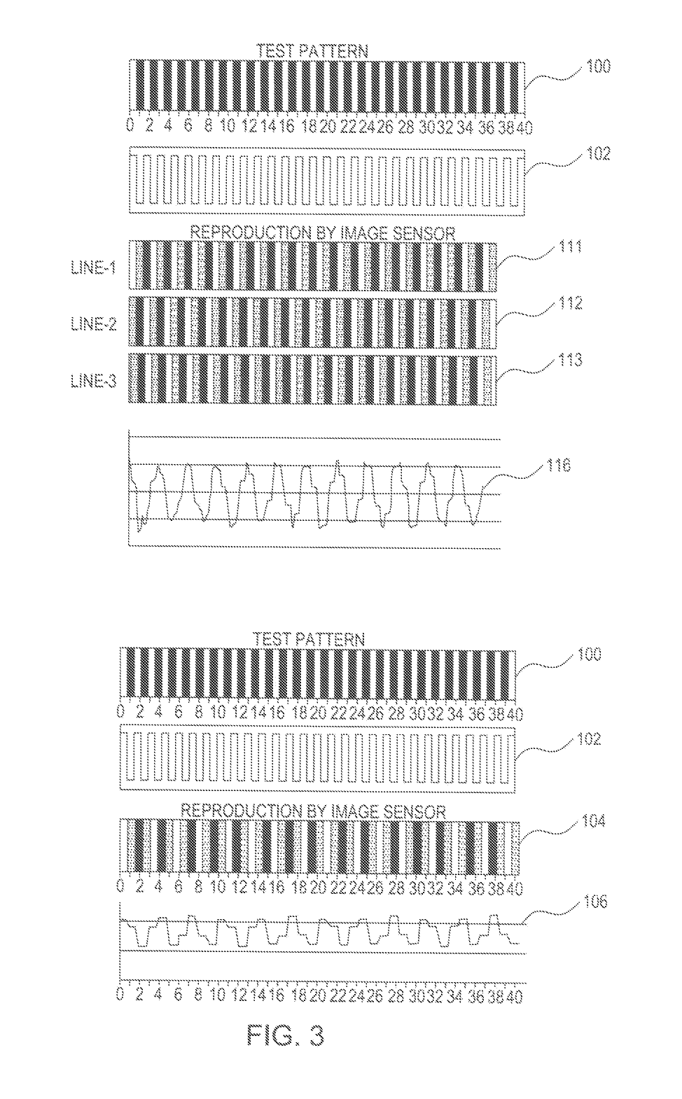

FIG. 3 illustrates a test pattern, acquired images, and digitized images according to an embodiment of the invention;

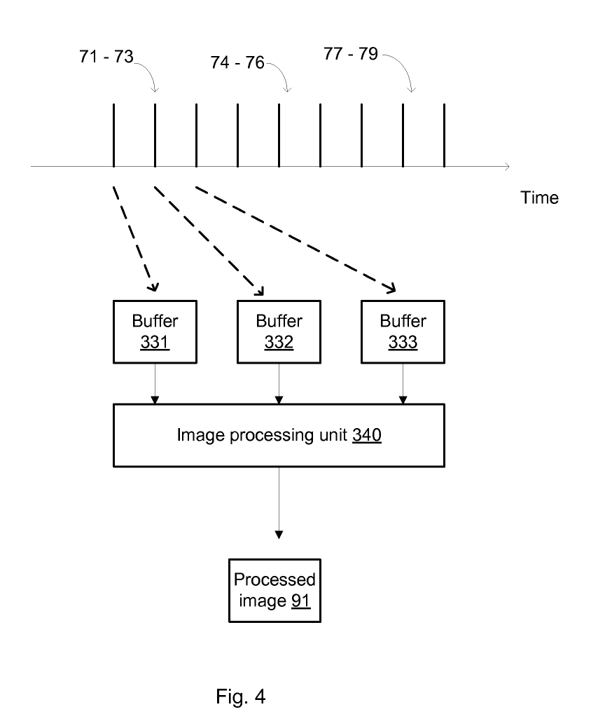

FIG. 4 illustrates an image processor unit that averages all three acquired images acquired per each PMP to provide a single processed image per PMP;

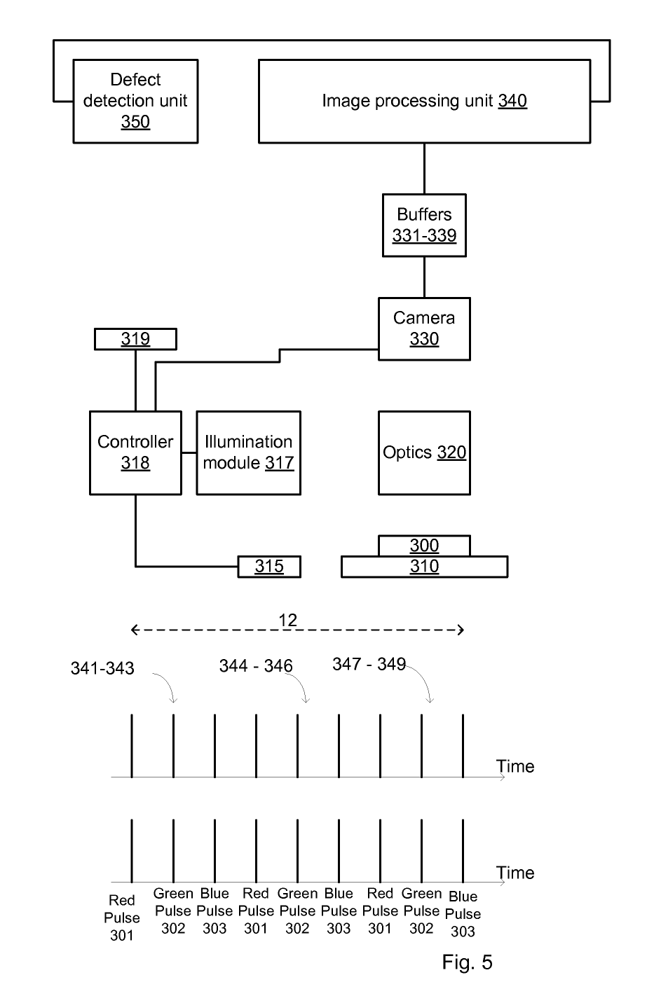

FIG. 5 illustrates an inspection system that generates red, green and blue acquired images, according to an embodiment of the invention;

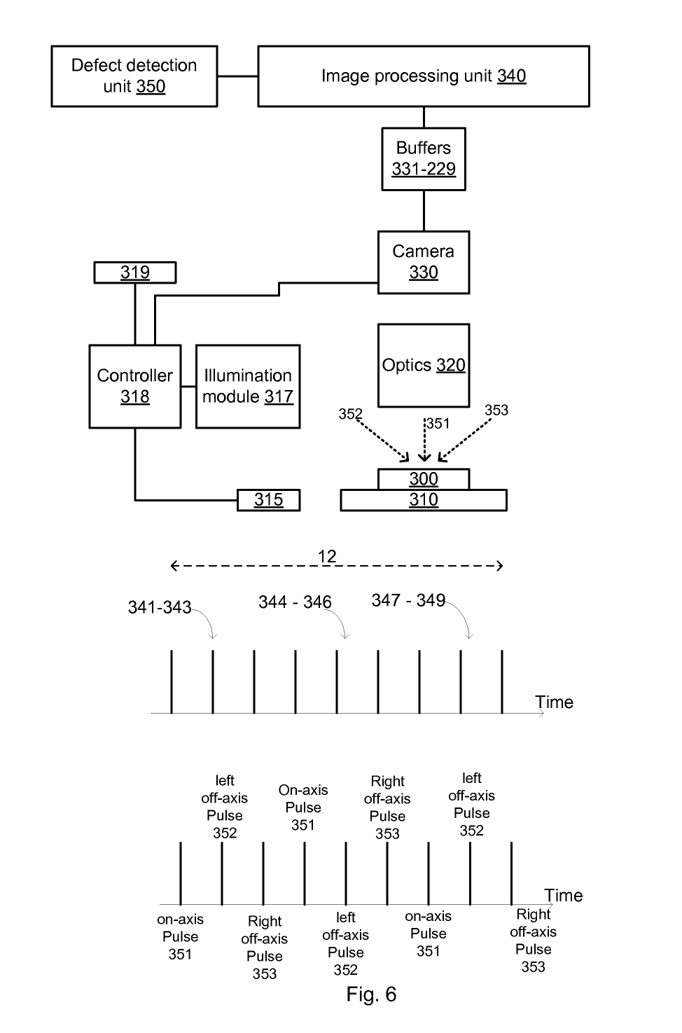

FIG. 6 illustrates an inspection system that alters the illumination angle, according to an embodiment of the invention;

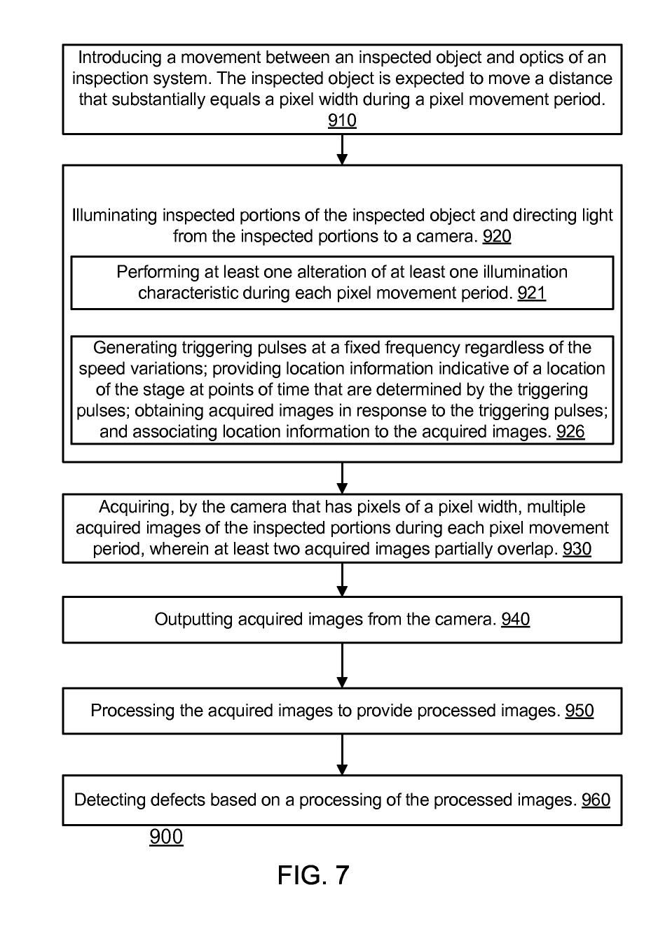

FIG. 7 illustrates a method for inspecting, according to an embodiment of the invention;

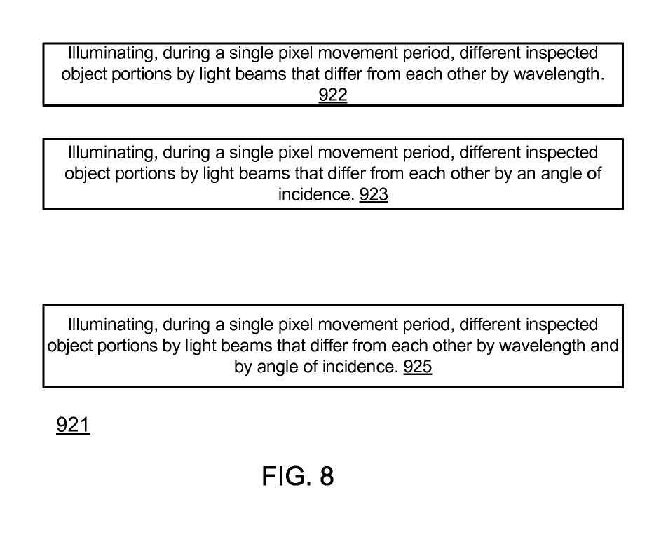

FIG. 8 illustrates a stage of illuminating an inspected object, according to an embodiment of the invention; and

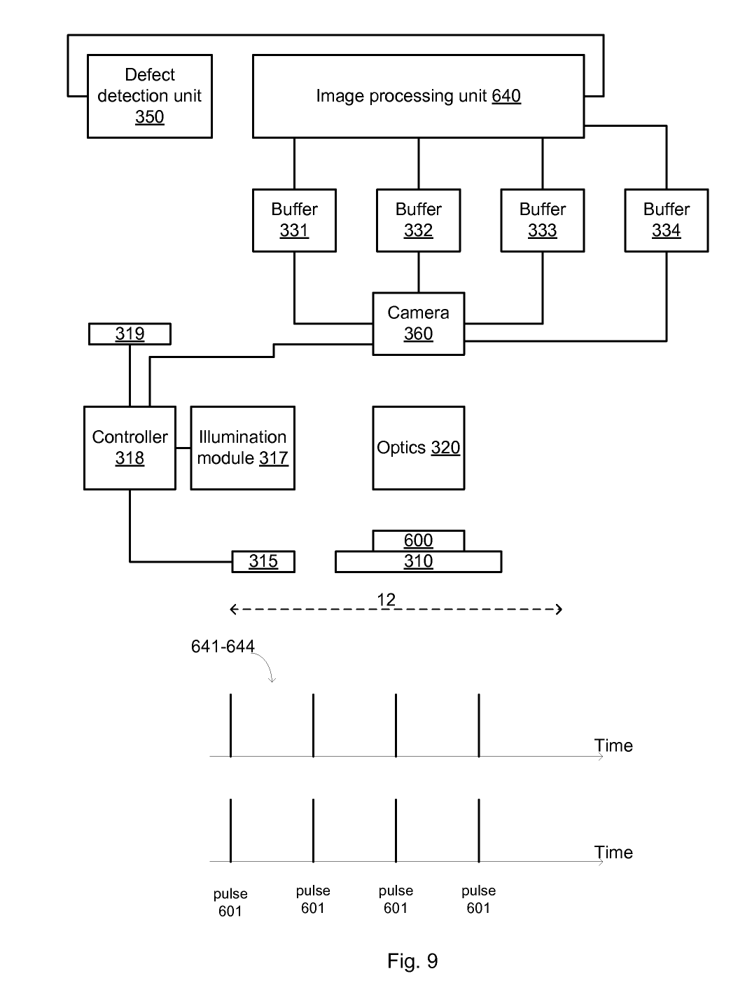

FIG. 9 illustrates an inspection system, according to an embodiment of the invention.

### DETAILED DESCRIPTION OF THE PRESENT INVENTION

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The term pixel movement period (PMP) means a period during which a inspected object is moved in relation to optics (or camera) of the inspection system by a distance that substantially equals a pixel width. It is noted that at least one out of the inspected object, the optics and the camera can be moved. The pixel width is the dimension (width) of an optically magnified pixel of the camera along a camera scan direction. Thus, if the sensor has pixels that are X micron wide and the magnification of optics located between the sensor and the inspected object is Y then the pixel width is X/Y microns.

New systems and methods for image acquisition are disclosed and can be used for optical inspection, especially of—by way of example—electronic circuit such as PCB, wafer, etc.

The systems and methods implement multiply sampling: motion of the inspected object is synchronized with a line period of a camera in a special mode: n acquired images are acquired per single pixel movement period (for example—per each PEG cycle). It is noted that the systems and method do not necessarily generate a PEG signal or do not trigger the acquisition of images based on a generation of the PEG signal.

The systems and methods can fulfill the following equation: n*EP<n*LP≦PMP, where: EP is the camera exposure period (the period during which the camera is open to obtain radiation to generate a single acquired image); LP is the camera line period—which can be equal to (or longer than) EP, PMP is the pixel movement period; and n is the number of multiply acquired images (number of acquired images acquired per PMP).

If n acquired images are acquired per PMP then these n acquired images can be regarded as a set of multiply n-acquired images and can be used for the formation of an n-dimensional processed image. For example, during a PMP three acquired images can be acquired—a red acquired image, a green acquired image and a blue acquired image (by applying a sequence of red illumination, green illumination and blue illumination) then these three acquired images (as well as images acquired during additional PMPs) can be processed to provide a single 3-dimensional processed image (or three single dimensional processed images). The same applies for n>3 multispectral acquired images.

The acquired images can also be processed while being subjected to some data reduction n→m, where n>m, to provide a less dimensional processed image with the prescribed properties. For example, n acquired images can be reduced by averaging to a single (synthetic) processed image with wider dynamic range, less noise and higher sharpness. In this case m=1.

Usually, the higher the n (the number of multiply acquired images per single PMP) and the higher data reduction ratio (for example n→1), the better image quality (sharpness, Signal to Noise Ratio and tiny defects visualization) can be achieved.

According to an embodiment of the invention, a method for inspection (and/or imaging) is disclosed.

The method includes scanning multiple (n) portions of an inspected object per single PMP. This may include receiving a single encoder PEG, and in response obtaining multiple acquired images (for example—by scanning multiple lines), wherein the receiving of the encoder PEGs and the scanning is reiterated. The method may also include issuing the PEGs, e.g. in response to timing information and/or to other types of information (e.g. camera position sensor). The issuing may conveniently be carried out by a motion control encoder of the system, by an external unit, and so forth. It is noted that the acquisition of the multiple images can be triggered by signals other than PEG signals.

According to an embodiment of the invention, for each PMP the method includes obtaining by a line camera, n-line acquired images of portions of the inspected object.

The acquired images can be obtained and processed to provide one or more (m) processed images. A single processed image may include up to m×n acquired images, where the m is the number of the processed images per single PEG, and the n is the number of PEG signals generated by the motion control encoder or the number of PMP allocated for obtaining the acquired images that form the basis of the processed image.

The method may continue with transferring each set of acquired images (which may possibly partly overlap each other) to an image processing unit (either of the same system or of an external system).

The method may continue with generating (e.g. by the image processing unit) at least one processed image of the inspected object (or of portions thereof), in response to the acquired images. In various embodiments of the invention, various types of images and processes for generating thereof may be implemented.

According to an embodiment of the invention, the method may continue with detecting, in response to the at least one processed image, defects in the inspected object (e.g. a wafer, a diced wafer, PCB, etc.), e.g. in an inspection system.

FIG. 2 illustrates three acquired images that are acquired during a single pixel movement period, according to an embodiment of the invention. For example, during a first PMP 10, three acquired images 71, 72 and 73 are acquired. There is an overlap of 2/3 pixels between two adjacent acquired images. The acquired images are acquired each line period 70 that is one third than the PMP.

Generally, when n images are acquired per PMP, there may be an overlap of about (n−1)/n pixels between two adjacent images.

Yet for another example, during a second PMP 12, three acquired images 74, 75 and 76 are acquired. There is an overlap of 2/3 pixels between two adjacent acquired images. The acquired images are acquired each line period 70 that is one third than the PMP.

FIG. 2 also illustrates acquired images that are processed to provide processed images that are formed from non-overlapping (or barely overlapping) acquired images.

The first acquired image (71, 74 . . . ) of each PMP can be processed to form a first processed image 81. The second acquired image (72, 75 . . . ) of each PMP can be processed to form a second processed image 82. The third acquired images (73, 76 . . . ) of each PMP can be processed to form a third processed image 83.

Alternatively, acquired images can be processed to provide processed images that include acquired images that include large overlaps. Thus, a single processed image can be generated per PMP by averaging all acquired images acquired during the PMP—as illustrated by processed images 91, 92 and 93.

It is noted that other combinations and processing methods of acquired images can be obtained. For example, processed images can be obtained by processing acquired images that have more or less overlap.

According to various embodiments of the invention, image processing can be carried out in one or more of the following locations: within the camera (e.g. similarly to a part of “smart camera” programmable image processing unit); within an acquisition card, externally to the camera, and so forth.

In systems and methods disclosed herein, the camera is working in higher rate than a system setting clock that determines the PMP, thus providing multiple sampling of the same object per each PMP.

FIG. 3 illustrates a test pattern 100, acquired images 104, 111-113, and digitized images 106 and 116 according to an embodiment of the invention.

Test pattern 100 includes a sequence of black and white stripes. Ideal digital image 102 illustrates an ideal digitized image of the test pattern, the ideal digitized image alternates between a maximal level to a minimal level.

A camera generates an acquired image 104 that include a variety of gray level stripes—including white stripes, black stripes and gray stripes of different values. The differences between the ideal digital image 102 and the acquired image 104 can be contributed to noises and to the imperfection of the image acquisition process. Graph 106 illustrates the gray levels of acquired image 104. It greatly deviates from the ideal digital image 102.

According to an embodiment of the invention a camera can obtain three acquired image 111-113, each including a variety of gray level stripes—including white stripes, black stripes and gray stripes of different values. All three acquired images 111-113 are averaged and graph 116 illustrates the gray levels of the averaged image. Graph 116 is much closer to the ideal digital image 102 in comparison to graph 106.

FIG. 4 illustrates an image processing unit 340 and nine buffers 331-339, each buffer receives a single acquired image per PMP. The image processing unit 340 retrieves the acquired images and averages all three acquired images (for example acquired images 71-73) that are acquired per each PMP to provide a single processed image per PMP such as processed image 91. Thus, each set of three acquired images (71-73), (74-76) and (77-79) is averaged to provide a single processed image, such as processed image 91. PMP can equal 90 μs, the camera line period can equal 30 μs and the exposure period can equal 29.7 μs.

The image processing unit 340 can be implemented, by way of example, on graphic ALTERA, CPU, GPU or any kind of processor or ASIC.

According to various embodiments of the invention, optical conditions (such as but not limited to angle of incidence, spectrum, shape of light beam, intensity profile of light beam, angle of collection, attenuation, and the like), can be fixed during each PMP, can be changed from one PMP to another or can be changed (once or more times) per PMP.

FIG. 5 illustrates an inspection system 295 that generates red, green and blue acquired images, according to an embodiment of the invention. FIG. 5 also includes a timing diagram that illustrates the acquisition of red, blue and green acquired images.

The inspected object 300 is positioned on a mechanical stage 310 and moves along a horizontal axis. The movement of the mechanical stage 310 can be monitored by an encoder 315 that may generate a PEG each PMP. The inspection system 295 can synchronize between the PEG and the acquisition of obtained images or otherwise control the timing of image acquisition by a controller 318.

FIG. 5 illustrates the controller 318 as being coupled to a signal generator 319 that may provide triggering pulses in fixed timing intervals. The controller 318 may, additionally or alternatively, receive PEGs or location information from a mechanical stage locator generator such as encoder 315. The location information indicates of a location of the mechanical stage 310 at points of time that are determined by the triggering pulses.

Inspected object 300 is repetitively illuminated by a sequence of a red pulse 301, a green pulse 302 and a blue pulse 303. This illumination causes camera 330 to acquire red acquired images, green acquired images and blue acquired images. These acquired images can be sent to different buffers 331-333. These buffers can be accessed by image processing unit 340. The image processing unit 340 is coupled to defect detection unit 350. It is noted that the image processing unit 340 and the defect detection unit 350 can be integrated.

FIG. 5 illustrates three sequences of these pulses per PMP. Thus, acquired images 341-349 are acquired per a single PMP—one image per camera line period 340. Acquired images 341, 344 and 347 are red acquired images, acquired images 342, 345 and 348 are green acquired images, and acquired images 343, 346 and 349 are blue acquired images.

It is noted that only one Red Green and Blue (RGB) sequence, two RGB sequences or more than three RGB sequences can be generated per PMP.

It is noted that although FIG. 5 illustrates each red, blue or green light pulses as being generated in a non-overlapping manner, that different combinations (simultaneous illumination by pulses of two colors) can be applied.

It is further notes that instead of using different light pulses, different filters (or a configurable filter) can be used to filter different spectral components of light.

It is further noted that although the optics 320 are illustrated as being parallel the inspected object this is not necessarily so. The optics 320 may includes a conventional objective lens, a reflective Imaging Array.

The camera 330 can be a line camera or an area camera. It can obtain multiple acquired images per PMP and can output these multiple obtained images per PMP. The camera can perform some form of processing (such as filtering, averaging, compression, and the like) on the acquired images before outputting these images. The camera 330 can include an array of CCD sensors or CMOS sensors, can include multiple lines (for example—include a red line of sensors, a green line of sensors and a blue line of sensors), can be a TDI or any array camera working in a line-scan mode.

FIG. 6 illustrates an inspection system 296 that alters the illumination angle, according to an embodiment of the invention. FIG. 6 also includes a timing diagram.

Inspection system 296 differs from the inspection system 295 by the manner in which it illuminates the inspected object 300.

The inspection system 296 illuminates the inspected object 300 by a sequence of (a) on-axis illumination 351 (for example—a normal incidence) to provide an on-axis acquired image such as 371, 374 and 377, (b) left off-axis illumination 352 to provide left off-axis images such as 372, 375 and 378, and (c) right off-axis illumination 353 to provide right off-axis images such as 373, 376 and 379.

FIG. 6 illustrates three sequences of these pulses per PMP. Thus, acquired images 371-379 are acquired per a single PMP—one image per camera line period 370.

It is noted that only one sequence, two sequences or more than three sequences can be generated per PMP.

It is noted that although FIG. 6 illustrates illumination pulses 351, 352 and 353 as being generated in a non-overlapping manner, that different combinations (simultaneous illumination by pulses of different illumination angles) can be applied.

It is further noted, in relation to FIGS. 5 and 6, that different combinations of illumination angles, spectrum of illumination or collection can be used.

Either one of inspection systems 295 and 296 can include an illumination module 317 that may apply pulsed illumination or continuous (DC) illumination. Illumination module can include one or more light sources. Different light sources can differ from each other by their illumination spectrum, intensity, phase, angle and the like. For example, the illumination module 317 can have a red light source, a blur light source and a green light source or a set of configurable filters that filter red, blue or green illumination. The same can be applied mutatis mutandis to the illumination module

Generally speaking, different acquired images may include complementary physical information of the inspected object of any nature: multi-spectral, polarization, 3D-vision, reflectance properties (bidirectional reflectance distribution function).

FIG. 9 illustrates an inspection system 297 that acquired four acquired images per PMP, according to an embodiment of the invention. FIG. 10 also includes a timing diagram.

Inspection system 297 differs from the inspection system 295 by the number of acquired images is acquires per PMP—four images (such as acquired images 641-644) and by having four buffers 331-334. The inspection system 297 is arranged to maintain the optical parameters fixed per PMP.

It is noted that a single inspection system can be configured to operate as either one of inspection systems 295, 296 and 297.

FIG. 7 illustrates method 900 for inspecting, according to an embodiment of the invention.

Method 900 starts by a sequence of stages. For simplicity of explanation stage 910 is illustrated as being followed by stages 920, 930, 940, 950 and 960 although repetition of these different stages can be executed in parallel or in a pipelined manner. For example, an inspected object can be moved in a continuous manner and during this movement multiple images are obtained, outputted and processed. Furthermore, an acquired image can be obtained while a previously acquired image is being outputted or processed.

Stage 910 includes introducing a movement between an inspected object and optics of an inspection system. The inspected object is expected to move a distance that substantially equals a pixel width during a pixel movement period. Stage 910 can include moving the inspected object, moving optics or both.

Stage 920 includes illuminating inspected portions of the inspected object and directing light from the inspected portions to a camera.

Stage 910 may include moving the inspected object by a movement that is characterized by speed variations. In this case stage 920 may include stage 926 of generating triggering pulses at a fixed frequency regardless of the speed variations; providing location information indicative of a location of the mechanical stage at points of time that are determined by the triggering pulses; obtaining acquired images in response to the triggering pulses; and associating location information to the acquired images.

Stage 930 includes acquiring, by the camera that has pixels of a pixel width, multiple acquired images of the inspected portions during each pixel movement period, wherein at least two acquired images partially overlap.

Stage 930 may include obtaining at least three acquired images of the inspected portions during each pixel movement period.

Stage 940 includes outputting acquired images from the camera.

Stage 950 includes processing the acquired images to provide processed images. It is noted that the processing or part of the processing can be performed before the camera outputs images and in this case stage 940 will include outputting processed or partially processed images by the camera.

Stage 960 includes detecting defects based on a processing of the processed images. This may include applying die to die, die to golden die, die to database, as well as any other defect detection algorithm.

Stage 950 may include merging different acquired images obtained during a single pixel movement period to provide one or more processed images.

Stage 950 may include comprising generating multiple processed images, each processed image comprises acquired images obtained during different pixel movement periods, wherein each of the acquired images is obtained at a same timing difference from a beginning of the pixel movement period during which the acquired image was obtained. For example, each of processed images 81-83 of FIG. 2 includes acquired images that were obtained at the same time within different PMPs.

Stage 920 may include stage 921 of performing at least one alteration of at least one illumination characteristic during each pixel movement period. FIG. 8 illustrates stage 921, according to an embodiment of the invention.

Stage 921 may include at least one of stages 922, 923, 924 and 925.

Stage 922 includes illuminating, during a single pixel movement period, different inspected object portions by light beams that differ from each other by wavelength. An example of such change is illustrated in FIG. 5.

Stage 923 includes illuminating, during a single pixel movement period, different inspected object portions by light beams that differ from each other by an angle of incidence. An example of such change is illustrated in FIG. 6.

Stage 924 includes collecting light from different inspected object portions, during a single pixel movement period, at collection angles that differ from each other.

Stage 925 includes illuminating, during a single pixel movement period, different inspected object portions by light beams that differ from each other by wavelength and by angle of incidence.

Each of inspection systems 295 and 296 and method 900 may have one or more of the following characteristics: (a) An improved CCD aliasing parameter and by that the CCD MTF parameter (readout noise decreasing leads to sharper edges, e.g. White-Black transitions, and thus to higher contrast); (b) CCD readout noise reduction when the number of processed images (m) is lower than the number (n) of acquired images that are processed to provide the processed images; (c) motion smearing reduction by use of shorter exposure period; (d) Increased dynamic range by noise reduction when n>m while maintaining the pixel signal intensity; (e) Improving tiny defect detection by general MTF improvement (especially at the high spatial frequencies): high spatial frequency means (tiny objects, meaning high density regular patterns and defects, are characterized by low signal and, hence, by low Signal-to Noise Ratio; Noise reduction leads to higher SNR and better contrast on tiny objects; (f) Improving image stability by shot noise averaging when n>m; and (g) obtaining multiply image information if applying special illumination conditions.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An inspection system, comprising:
a camera;
a mechanical stage, for introducing a movement between an inspected object and optics of the inspection system; wherein the inspected object is expected to move a distance that substantially equals a pixel width during a pixel movement period;
an illumination module and optics for illuminating inspected portions of the inspected object and for directing light from the inspected portions to the camera; and
wherein the camera is arranged to acquire multiple acquired images of the inspected portions during each pixel movement period, wherein at least two acquired images partially overlap.

2. The inspection system according to claim 1, comprising: an image processing unit for processing the acquired images to provide processed images; and a defect detection unit for detecting defects based on a processing of the processed images.

3. The inspection system according to claim 2, wherein the image processing unit merges different acquired images obtained during a single pixel movement period.

4. The inspection system according to claim 2, wherein the image processing unit generates multiple processed images, each processed image comprises acquired images obtained during different pixel movement periods, wherein each of the acquired images is obtained at a same timing difference from a beginning of the pixel movement period during which the acquired image was obtained.

5. The inspection system according to claim 1 wherein the illumination module is arranged to perform at least one alteration of at least one illumination characteristic during each pixel movement period.

6. The inspection system according to claim 1 wherein the illumination module is arranged to illuminate, during a single pixel movement period, different inspected object portions by light beams that differ from each other by wavelength.

7. The inspection system according to claim 1, further adapted to illuminate, during a single pixel movement period, different inspected object portions by light beams that differ from each other by an angle of incidence.

8. The inspection system according to claim 1 wherein the illumination module is arranged to illuminate, during a single pixel movement period, different inspected object portions by light beams that differ from each other by wavelength and by angle of incidence.

9. The inspection system according to claim 1 wherein the camera is arranged to obtain at least three acquired images of the inspected portions during each pixel movement period.

10. The inspection system according to claim 1, wherein the mechanical stage is arranged to move the inspected object by a movement that is characterized by speed variations; wherein the inspection system further comprises:
a signal generator, for generating triggering pulses at a fixed frequency regardless of the speed variations;
a mechanical stage location generator, for providing location information indicative of a location of the mechanical stage at points of time that are determined by the triggering pulses;
wherein the camera is arranged to obtain acquired images in response to the triggering pulses; and
wherein the image processing unit is arranged to associate location information to the acquired images.

11. A method for inspecting, comprising:
introducing a movement between an inspected object and optics of an inspection system; wherein the inspected object is expected to move a distance that substantially equals a pixel width during a pixel movement period;
illuminating inspected portions of the inspected object and directing light from the inspected portions to a camera; and
acquiring, by the camera that has pixels of a pixel width, multiple acquired images of the inspected portions during each pixel movement period, wherein at least two acquired images partially overlap.

12. The method according to claim 11, comprising processing the acquired images to provide processed images; and detecting defects based on a processing of the processed images.

13. The method according to claim 12, comprising merging different acquired images obtained during a single pixel movement period.

14. The method according to claim 12, comprising generating multiple processed images, each processed image comprises acquired images obtained during different pixel movement periods, wherein each of the acquired images is obtained at a same timing difference from a beginning of the pixel movement period during which the acquired image was obtained.

15. The method according to claim 11, comprising performing at least one alteration of at least one illumination characteristic during each pixel movement period.

16. The method according to claim 11, comprising illuminating, during a single pixel movement period, different inspected object portions by light beams that differ from each other by wavelength.

17. The method according to claim 11, comprising illuminating, during a single pixel movement period, different inspected object portions by light beams that differ from each other by an angle of incidence.

18. The method according to claim 11, comprising illuminating, during a single pixel movement period, different inspected object portions by light beams that differ from each other by wavelength and by angle of incidence.

19. The method according to claim 11, comprising obtaining at least three acquired images of the inspected portions during each pixel movement period.

20. The method according to claim 11, comprising moving the inspected object by a movement that is characterized by speed variations; wherein the method further comprises:
generating triggering pulses at a fixed frequency regardless of the speed variations;
providing location information indicative of a location of the mechanical stage at points of time that are determined by the triggering pulses;
obtaining acquired images in response to the triggering pulses; and
associating location information to the acquired images.
